(19) United States
(12) Patent Application Publication
(10) Pub. No.: US 2021/0275402 A1
(43) Pub. Date: Sep. 9, 2021

(54) CLIP-FREE PACIFIER HOLDER AND GARMENT THEREWITH

(71) Applicant: Lorri B. Noble, Wetumpka, AL (US)

(72) Inventor: Lorri B. Noble, Wetumpka, AL (US)

(21) Appl. No.: 17/303,305

(22) Filed: May 26, 2021

Related U.S. Application Data
(63) Continuation-in-part of application No. 17/248,305, filed on Jan. 19, 2021.
(60) Provisional application No. 62/937,406, filed on Nov. 19, 2019.

(51) Int. Cl. A61J 17/00

(52) U.S. Cl. CPC A61J 17/111; A61J 17/001

(57) ABSTRACT

A clip-free pacifier holder device includes a fabric article and a pacifier holder strap, stitched into an upper portion of the fabric article at a first end. A second end of the strap has a way of attaching an accessory. The fabric article may be a garment. A pacifier-retaining child's garment has an integral pacifier holder. The pacifier holder includes a fabric strap extending from an upper portion of the child's garment. The strap has an attachment component at one end.

### CROSS-REFERENCE TO RELATED APPLICATION

This application is a continuation-in-part of U.S. nonprovisional application Ser. No. 17/248,305, filed Jan. 19, 2021, which claimed the benefit of priority to U.S. provisional application No. 62/937,406, filed Nov. 19, 2019, the contents of which are herein incorporated by reference.

### BACKGROUND OF THE INVENTION

The present invention relates to a clip-free pacifier holder and, more particularly, to a garment comprising a clip-free pacifier holder.

Currently available child shirts and one-piece garments do not provide a way to attach a pacifier. A separate pacifier holder must be attached to the garment.

The currently available pacifier holders comprise a metal or plastic clip which presents potential dangers. The clip may pose a choking hazard when a child chews on it. A metal clip may also rust over time due to the child's saliva. The pacifier holder no longer serves its purpose if the child pulls the entire pacifier holder off the garment or if the clip breaks apart or otherwise breaks away from the pacifier holder. The clip may also damage the child's garment when crimping the material. From birth, children requiring a pacifier use this system and are susceptible to these potential dangers.

As can be seen, there is a need for a clip-free pacifier holder that does not pose a choking hazard and does not damage a garment to which it is attached.

### SUMMARY OF THE INVENTION

In one aspect of the present invention, a clip-free pacifier holder device is provided, comprising a fabric article and a pacifier holder strap, a first end of which is stitched into an upper portion of the fabric article and a second end of which has an attachment means.

In another aspect of the present invention, a pacifier-retaining garment is provided, comprising a child's garment with an integral pacifier holder formed therein, said pacifier holder comprising a fabric strap extending from an upper portion of the child's garment, said fabric strap having an attachment means at an end thereof.

These and other features, aspects and advantages of the present invention will become better understood with reference to the following drawings, description, and claims.

### BRIEF DESCRIPTION OF THE DRAWINGS

FIG. 1 is a pacifier-holding one-piece garment according to an embodiment of the present invention, shown in use;

FIG. 2 is a front elevation view thereof;

FIG. 3 is a detail view of a shoulder thereof, showing a sewn-in pacifier-holding strap;

FIG. 4 is a detail view of a stretchable cord thereof, shown holding a pacifier;

FIG. 5 is a pacifier-holding shirt according to another embodiment of the present invention;

FIG. 6 is a pacifier-holding one-piece garment according to another embodiment of the present invention;

FIG. 7 is a detail view thereof, showing a buttoned-on pacifier-holding strap;

FIG. 8 is a pacifier-holding one-piece garment according to another embodiment of the present invention;

FIG. 9 is a pacifier-holding one-piece garment according to another embodiment of the present invention; and

FIG. 10 is a detail view of a shoulder thereof, showing a pacifier-holding strap snapped in.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “one-piece garment” refers to infant or toddler garments including gowns, jumpers, rompers, bodysuits, sleepers, overalls, pajamas, and dresses, such as garments known as ONESIES™.

The term “mating attachment means” refers to a component that is operative to couple to or mate to a specified attachment means. For example, if the specified attachment means is described as a snap, it is either a male portion (i.e., stud) and the mating attachment means is the female portion (i.e., socket) of the snap, or it is the female portion and the mating attachment means is the male portion of the snap. If the specified attachment means is a button, the mating attachment means is a buttonhole. If the specified attachment means is a hole, the mating attachment means may be a cord loop.

As used herein, the term “integral” means that the components are made together as a single unit.

Broadly, one embodiment of the present invention is a clip-free pacifier holder system, i.e., devoid of any clip. The invention eliminates the need for a metal or plastic clip and the potential danger and problems associated with it.

The pacifier holder system may be a clip-free garment accessory attachment system attached to any garment, such as a child's shirt, a child's one-piece garment, or an adult upper garment, such as a dress, shirt, pajama top, etc.

The pacifier holder system is not particularly limited to use with a pacifier and may hold any accessory with a hole or opening, such as eyeglasses, sunglasses, a teether, a toy, a global positioning system (GPS) tracker, accessories, etc. to the garment. The pacifier or accessory may be attached to the pacifier holder using attachment means selected from the group consisting of a cord loop, a snap, and hook-and-loop closure, such as Velcro®.

In some embodiments, the pacifier holder may comprise a cord loop at both ends and may be attached to any garment or equipment having a mating hole. In this case, the cord loop at a first end of the pacifier holder may be inserted through the hole in the garment or equipment, and the cord loop at a second end of said pacifier holder may be inserted through a pacifier or other accessory comprising a handle or hole. In some embodiments, a hole may be formed in the upper portion of a child shirt or one-piece garment. The top end of the pacifier holder may be looped through said hole.

In some embodiments, the present invention comprises a clip-free pacifier holder comprising a buttonhole at a first end and a cord loop at a second end. The pacifier holder may be attached to any existing shirt or one-piece garment comprising a button. Said pacifier holder may attach to the garment by inserting the button into the pacifier holder buttonhole. The invention may also comprise a child shirt or one-piece garment with a button at the shoulder or chest area.

In some embodiments, a clip-free pacifier holder device includes a first or top end of a pacifier holder may be sewn into a fabric article selected from the group consisting of: the upper portion of any garment; a swaddle blanket or wrap; a baby-wearing garment, such as a sling carrier or buckle carrier; a car seat cover; a crib sheet; a baby lounger; and a stuffed animal. A second or bottom end of the pacifier holder comprises a cord loop operative to attach a pacifier.

In some embodiments, the present invention comprises a child shirt or one-piece garment comprising the socket end of a snap (i.e., the snap socket) at the shoulder area and a clip-free pacifier holder comprising the stud end of a snap (i.e., the snap stud) at the top end and a cord loop at the bottom end. Said pacifier holder may attach to the garment by snapping the snap-stud of the pacifier holder to the snap-socket of the garment. In some embodiments, the pacifier holder may comprise the socket end and the garment may comprise the stud end. When the pacifier holder has a snap stud at the top end, the bottom end of the pacifier holder does not include a releasable loop comprising a snap.

To use the inventive pacifier holder, a user may insert the cord loop through a pacifier handle or shield hole, bring the cord loop around the remainder of the pacifier, and then gently pull the pacifier to secure the pacifier to the loop.

The materials of manufacture are not particularly limited. The pacifier holder strap may be made from the same material as the surrounding garment. The cord loop may be resiliently elastic (i.e., stretchable), for example.

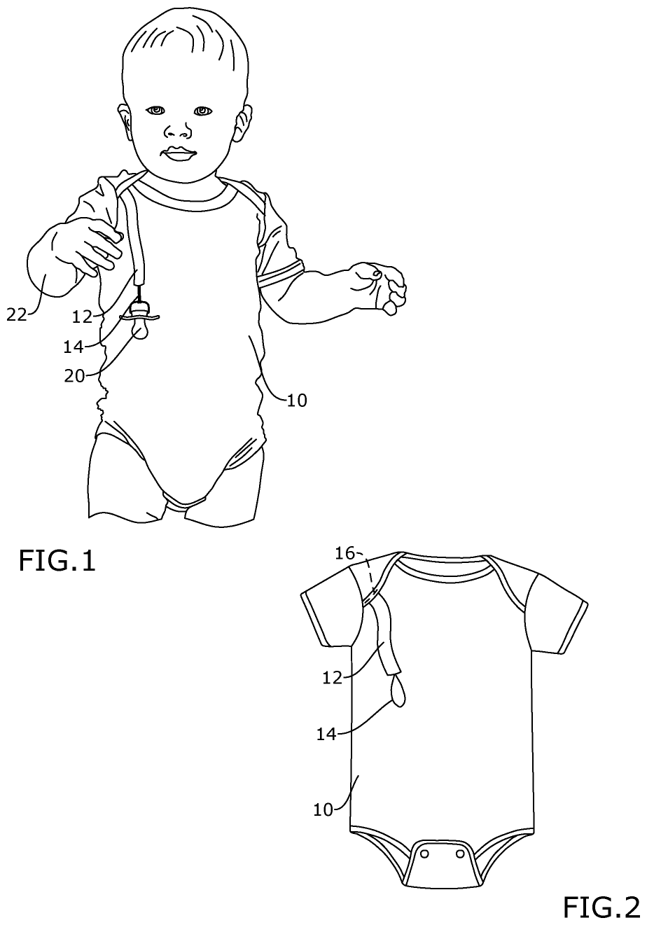

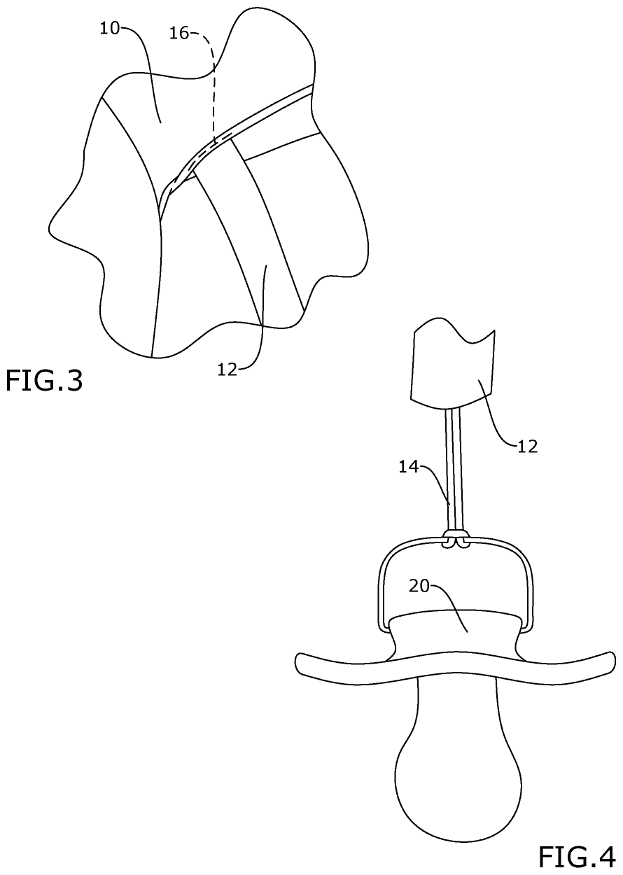

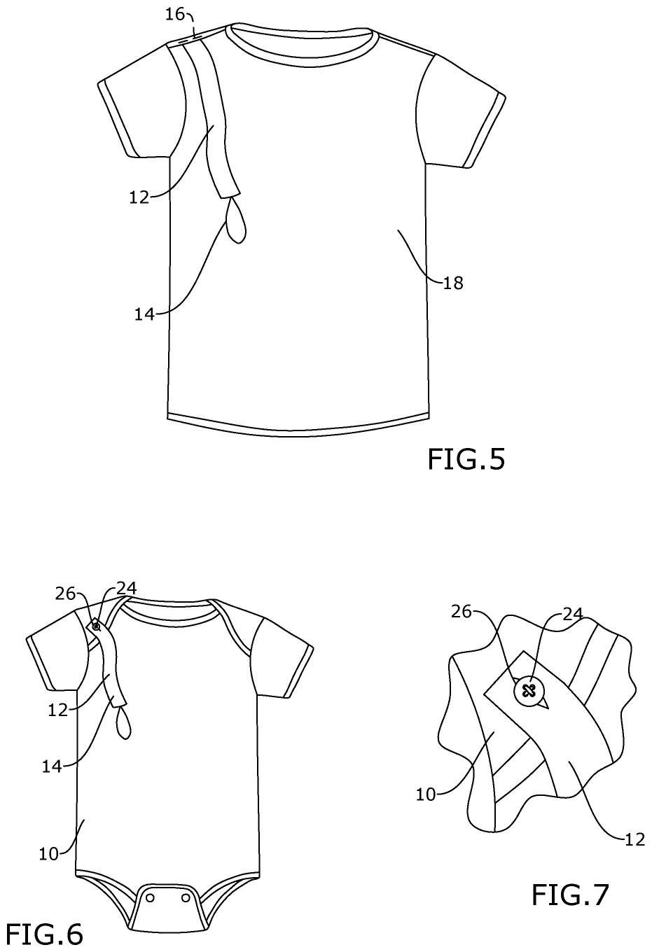

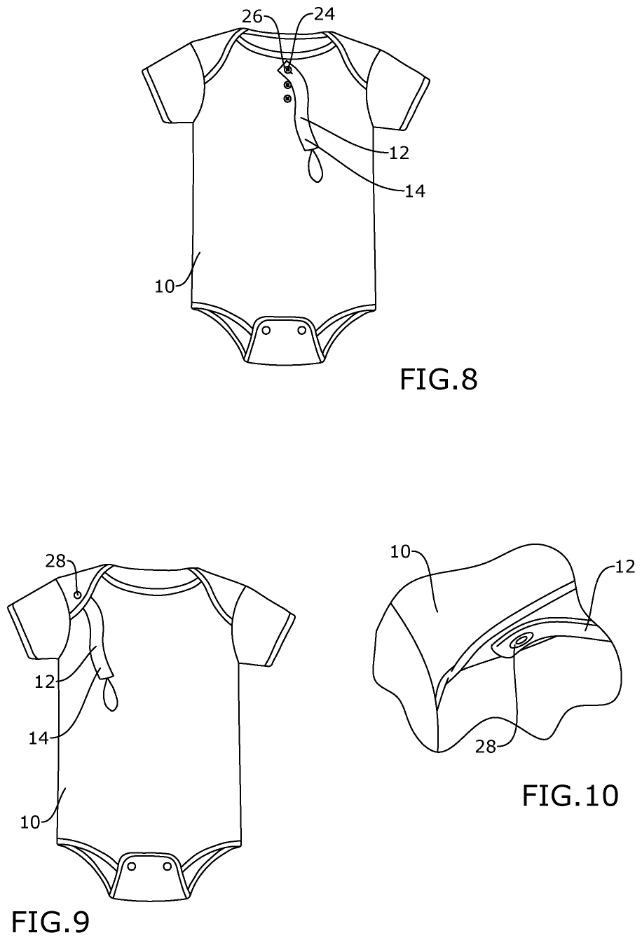

Referring to FIGS. 1 through 10, FIGS. 1 through 3 illustrate a pacifier holder sewn into a one-piece garment 10. The pacifier holder comprises a strap 12, attached to the garment 10 at the wearer's 22 shoulder with stitching 16, and a stretchable cord 14. FIG. 4 illustrates attachment of a pacifier 20 to the stretchable cord 14. FIG. 5 illustrates the pacifier holder strap 12 stitched 16 into a shirt 18 shoulder. FIGS. 6 through 8 illustrate a pacifier holder strap 12 with a buttonhole 26 operative to attach to a garment 10 button 24, pre-existing or added thereto, which may be positioned at the shoulder or at the chest. FIGS. 9 and 10 illustrate a pacifier holder with a strap 12 removably attached to a garment 10 by way of a snap 28.

Alternative embodiments include the following.

Embodiment 1 includes a clip-free pacifier holder, comprising a strap having a first attachment means at a first end and a second attachment means at a second end, provided that the second attachment means is not a releasable loop comprising a snap.

Embodiment 2 includes the clip-free pacifier holder of embodiment 1, wherein the first attachment means is selected from the group consisting of: a buttonhole; a cord loop; a snap; and a hook and loop closure.

Embodiment 3 includes the clip-free pacifier holder of embodiments 1 or 2, wherein the second attachment means is selected from the group consisting of: a cord loop; and a hook and loop closure.

Embodiment 4 includes the clip-free pacifier holder of any one of embodiments 1-3, wherein the first attachment means is a cord loop and the second attachment means is a cord loop.

Embodiment 5 includes the clip-free pacifier holder of any one of embodiments 1-4, wherein the first attachment means is a buttonhole and the second attachment means is a cord loop.

Embodiment 6 includes a clip-free garment accessory attachment system, comprising a garment having a button, a hole, or a snap on an upper portion of the garment and a strap having a mating attachment means at a first end said of the strap operative to couple to the upper portion of the garment and a second attachment means at a second end of the strap, provided that the second attachment means is not a snap.

Embodiment 7 includes the clip-free garment accessory attachment system of embodiment 6, wherein the mating attachment means is selected from the group consisting of: a buttonhole; a cord loop; and a snap.

Embodiment 8 includes the clip-free garment accessory attachment system of embodiments 6 or 7, wherein the second attachment means is selected from the group consisting of: a cord loop; and a hook and loop closure.

Embodiment 9 includes the clip-free garment accessory attachment system of any one of embodiments 6-8, wherein the garment is an adult upper garment.

Embodiment 10 includes the clip-free garment accessory attachment system of any one of embodiments 6-9, wherein the garment comprises an end of a snap stud and the mating attachment means is a snap socket, or the garment comprises a snap socket and the mating attachment means is a snap stud.

Embodiment 11 includes the clip-free garment accessory attachment system of any one of embodiments 6-10, wherein the garment has a hole in the upper portion thereof and the mating attachment means is a cord loop.

Embodiment 12 includes the clip-free garment accessory attachment system of any one of embodiments 6-11, wherein the garment has a button in the upper portion thereof and the mating attachment means is a buttonhole.

It should be understood, of course, that the foregoing relates to exemplary embodiments of the invention and that modifications may be made without departing from the spirit and scope of the invention as set forth in the following claims.

What is claimed is:

1. A clip-free pacifier holder device, comprising:
a) a fabric article; and
b) a pacifier holder strap, a first end of which is stitched into an upper portion of the fabric article and a second end of which has an attachment means.

2. The clip-free pacifier holder device of claim 1, wherein the attachment means is selected from the group consisting of: a cord loop; a snap; and a hook and loop closure.

3. The clip-free pacifier holder device of claim 1, wherein the fabric article is selected from the group consisting of: a garment; a swaddle blanket; a wrap; a baby-wearing garment; a car seat cover; a crib sheet; and a baby lounger.

4. The clip-free pacifier holder device of claim 3, wherein the garment is an adult upper garment.

5. The clip-free pacifier holder device of claim 3, wherein the garment is a child's garment selected from the group consisting of: a gown, a jumper, a romper, a bodysuit, a sleeper, overalls, pajamas, and a dress.

6. A pacifier-retaining garment, comprising a child's garment with an integral pacifier holder formed therein, said pacifier holder comprising a fabric strap extending from an upper portion of the child's garment, said fabric strap having an attachment means at an end thereof.

7. The pacifier-retaining garment of claim 6, wherein the child's garment and the fabric strap comprise a fabric material, such that the fabric strap has the same fabric material as the child's garment.
